(19) United States
(12) Patent Application Publication
(10) Pub. No.: US 2025/0239051 A1
(43) Pub. Date: Jul. 24, 2025

(54) TRAINING METHOD AND SYSTEM FOR NEURAL NETWORK MODEL

(71) Applicant: InSign Medical Technology (Hong Kong) Ltd., Hong Kong (CN)

(72) Inventors: Yi-Ta Wu, Hong Kong (CN); Cheng-Long Wang, Hong Kong (CN); Kuang-Ting Hsiao, Hong Kong (CN); Fu-Chieh Chang, Hong Kong (CN)

(21) Appl. No.: 19/028,170

(22) Filed: Jan. 17, 2025

(30) Foreign Application Priority Data
Jan. 18, 2024 (CN) 202410076736.0

(51) Int. Cl. G06V 10/764; G06V 10/82

(52) U.S. Cl. CPC G06V 10/764; G06V 10/82

(57) ABSTRACT

A training system for a neural network model includes a memory and a processor. The memory is configured for storing the neural network model and several instructions. The processor is configured for executing the instructions to perform a training method including: (a) receiving an image data; (b) performing a feature calculation based on the image data to obtain a feature data; (c) performing a linear classification calculation based on the feature data by using a mathematical operator; (d) performing a non-linear classification calculation based on the feature data by using a non-linear operator and another mathematical operator; and (e) performing a combination calculation based on a first result of the linear classification calculation and a second result of the non-linear classification calculation.

### RELATED APPLICATIONS

This application claims priority to Chinese Patent Application, No. CN 202410076736.0, by Wu, et al., titled “TRAINING METHOD AND SYSTEM FOR NEURAL NETWORK MODEL,” filed on Jan. 18, 2024, which is hereby incorporated by reference in their entirety.

### BACKGROUND OF THE INVENTION

### Technical Field

The present invention relates to a method and system for an artificial intelligence. More particularly, the present invention relates to a training method and system for a neural network model.

### Description of Related Art

Machine learning is one of the major methods for implementing artificial intelligence. In particular, the algorithm of machine learning and training utilizing neural networks has become the mainstream of implementing artificial intelligence in recent years.

One of the mainstream applications of artificial intelligence is image processing and recognition. First, a neural network model is trained by using images of known categories, and then the trained neural network model is used to classify unknown images. However, it still exists the need for making the neural network model more sensitive to certain features of the images so it can detect images with these subtle features.

In the Chinese patent application filed on Apr. 12, 2022, numbered CN202210378982.2, titled “NEURAL NETWORK MODEL TRAINING METHOD AND SYSTEM,” and the Chinese patent application filed on Feb. 16, 2023, numbered CN202310125389.1, titled “NEURAL NETWORK MODEL TRAINING METHOD AND SYSTEM,” different hybrid neural networks are respectively proposed, which combines linear convolution calculation and non-linear convolution calculation to improve the performance of deep learning networks. Additionally, a new combination layer is proposed to more effectively combine the results of convolution calculations and non-linear convolution calculations. However, the contents of the known arts are only limited to feature extraction in image data, which is not beneficial to the application of other layers in the neural network model.

### SUMMARY

In view of the above-mentioned problems, the present invention is to provide a training method and training system for neural network model.

According to one aspect of the invention, a training method for a neural network model is provided. The training method includes the following steps: (a) receiving an image data; (b) performing a feature calculation based on the image data to obtain a feature data; (c) performing a linear classification calculation based on the feature data by using a mathematical operator; (d) performing a non-linear classification calculation based on the feature data by using a non-linear operator and another mathematical operator; and (e) performing a combination calculation based on a first result of the linear classification calculation and a second result of the non-linear classification calculation.

In one embodiment, the step (c) is performed G times, and the g^{th} time linear classification calculation is performed by way of using the first result of the (g−1)^{th} time linear classification calculation as the feature data, where G≥2 and G≥g≥2.

In one embodiment, the step (e) is performed based on the first result of the G^{th} time linear classification calculation and the second result of the non-linear classification calculation.

In one embodiment, the step (b) includes: performing a linear feature calculation to obtain a linear feature data.

In one embodiment, the step (c) includes: (c1) performing a first fully connected layer calculation based on the linear feature data; (c2) performing a second fully connected layer calculation based on a third result of the step (c1); and (c3) updating a fourth result of the step (c2) based on an activation function.

In another embodiment, the step (d) is performed H times, and the h^{th} time non-linear classification calculation is performed by way of using the second result of the (h−1)^{th} time non-linear classification calculation as the feature data, where H≥2 and H≥h≥2.

In another embodiment, the step (e) is performed based on the first result of the linear classification calculation and the second result of the H^{th} time non-linear classification calculation.

In another embodiment, the step (b) includes: performing a non-linear feature calculation to obtain a non-linear feature data.

In another embodiment, the step (d) includes: (d1) performing a first fully connected layer calculation based on the non-linear feature data; (d2) performing a second fully connected layer calculation based on a fifth result of the step (d1); and (d3) updating a sixth result of the step (d2) based on an activation function.

According to another aspect of the invention, a training system for a neural network model is provided. The training system includes a memory and a processor. The memory is configured for storing the neural network model and a plurality of instructions. The processor is configured for executing the instructions to perform a training method including the steps of: (a) receiving an image data; (b) performing a feature calculation based on the image data to obtain a feature data; (c) performing a linear classification calculation based on the feature data by using a mathematical operator; (d) performing a non-linear classification calculation based on the feature data by using a non-linear operator and another mathematical operator; and (e) performing a combination calculation based on a first result of the linear classification calculation and a second result of the non-linear classification calculation.

The training method and training system for the neural network model according to the disclosure of the embodiments of the invention has advantages including but not limited to the followings. By using feature data to perform both the linear classification calculation and the non-linear classification calculation, and then combining the results of the linear classification calculation and non-linear classification calculation, the efficiency of the training method and the training system can be improved. The trained neural network model can achieve higher efficiency and can provide enhanced feature sensitivity, which increases the resolution and accuracy of the neural network model while performing classifications. The training method and training system is more advantageous in a variety of applications relating to image classification computations.

### BRIEF DESCRIPTION OF DRAWINGS

The invention can be more fully understood by reading the following detailed description of the embodiment, with reference made to the accompanying drawings as follows:

FIG. 1 is a functional block diagram of a training system for a neural network model according to one embodiment of the invention;

FIG. 2 is a flow chart of a training method for neural network model according to one embodiment of the invention;

FIG. 3 is a detail flow chart of the linear and non-linear classification calculations according to one embodiment of the invention;

FIG. 4 is a schematic diagram of two fully connected layer calculations according to one embodiment of the invention;

FIG. 5 is a detail flow chart of the linear and the non-linear classification calculations according to another embodiment of the invention;

FIG. 6 is a detail flow chart of the linear and the non-linear classification calculations according to a further embodiment of the invention;

FIG. 7 is a detail flow chart of the linear and the non-linear classification calculations according to yet another embodiment of the invention;

FIG. 8 is a detail flow chart of feature calculation according to one embodiment of the invention;

FIG. 9 is a detail flow chart of a linear feature calculation according to one embodiment of the invention;

FIG. 10 is a detail flow chart of a non-linear feature calculation according to one embodiment of the invention; and

FIG. 11 is a schematic diagram of the architecture of a training system according to one embodiment of the invention.

### DETAILED DESCRIPTION

The technical means implemented in the embodiment of the invention to achieve the objects of the invention are elaborated in conjunction with the accompanying drawings. It should be understood by those skilled in the art that the directional terms provided in the specific embodiments of the invention, such as up, down, left, right, front, or back, are only used for reference to the directions in the accompanying drawings and not to limit the invention. Furthermore, without departing from the spirit and scope of the invention, numerous changes and modifications can be made by those skilled in the art, and such derived examples will also fall within the scope of the invention.

A training method and a training system for a neural network model are provided in the embodiments of the invention. A feature calculation is applied to a received image data to obtain a feature data. The feature data is then subjected to a linear classification calculation and a non-linear classification calculation. Afterwards, a combination calculation is applied to the results of the linear and non-linear classification calculations. By using the feature data to perform both the linear classification calculation and the non-linear classification calculation, the efficiency of the training method and the training system can be improved. The trained neural network model can achieve higher efficiency and can provide increased feature sensitivity, which improves the resolution and accuracy of the neural network model while performing classifications. The training method and training system is more advantageous as implemented in a variety of image classification computations.

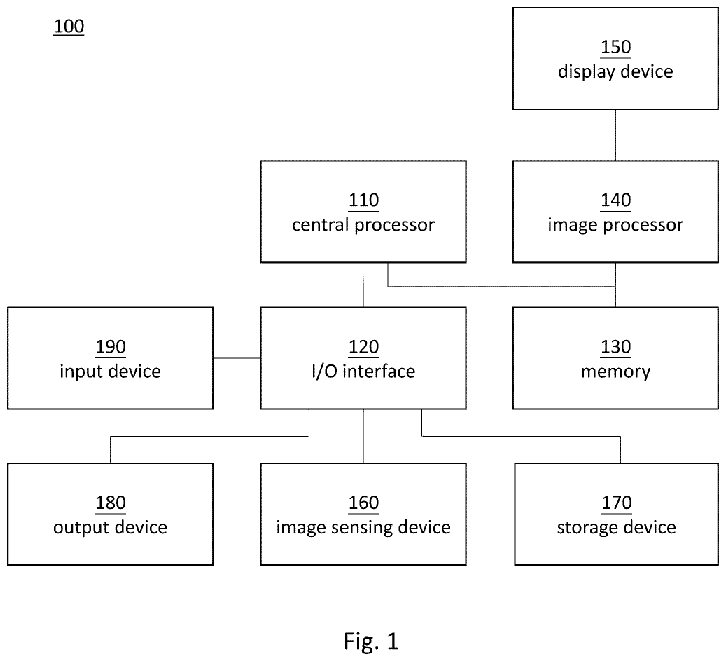

Please refer to FIG. 1, which is a functional block diagram of a training system for a neural network model according to one embodiment of the invention. The training system 100 for the neural network model includes a central processor 110 for executing an operating system, thereby controlling the operation of the training system 100. The instruction set used by the central processor 110 and the operating system used here are not limited in the embodiments of the invention. For example, the central processor 110 can include one or more processor chips, each of which can include one or more processing cores. The instruction set used by the processing cores can include common arithmetic and logic operations, as well as special vector instructions, which are particularly suitable for processing neural networks.

The training system 100 includes an I/O interface 120 for connecting various output devices 180 and input devices 190. For example, the output device 180 may include speaker, buzzer, light, other similar devices, or any combination thereof, which is used to produce sound or light to prompt or alert the user. The input device 190 may include keyboard, mouse, trackball, touchpad, touchscreen, scanner, microphone, other similar devices, or any combination thereof, which is used to input external information into the training system 100. The I/O interface 120 can also connect to wired or wireless network devices, such as Bluetooth devices, WiFi devices, IEEE 802.3 compatible devices, fourth-generation or fifth-generation wireless communication systems, or other similar wireless communication devices.

In the present embodiment, the I/O interface 120 can also be used to connect an image sensing device 160 and/or a storage device 170. The image sensing device 160 may include photographic or video sensing components for sensing light in various spectra. The image sensing device 160 may include a buffer memory for temporarily storing the images picked up by the sensing component. The images are then transmitted to the central processor 110 and/or memory 130. In one embodiment, the image sensing device 160 may be an endoscope. The storage device 170 may be a traditional floppy disk drive, an optical drive, a hard disk drive, or a solid-state storage device. In one embodiment, the image sensing device 160 and the storage device 170 may be integrated as one device.

The memory 130 may include multiple stages of memories. For example, a hierarchy of dynamic random-access memory (DRAM) and static random-access memory (SRAM). The memory 130 can be used to store multiple instructions and various data, such as the aforementioned operating system and applications suitable for the operating system. In one embodiment, the memory 130 can store the neural network model provided by the embodiments of the invention.

In one embodiment, the training system can further include an image processor 140. The central processor 110 and the image processor 140 can share the memory 130 and transmit a large amount of data via the memory 130. The hardware computing resources of the image processor 140 can also be used to realize the training method for the neural network provided in the embodiments of the invention. The training system 100 can further include a display device 150 which is connected to the image processor 140. The display device 150 can be used to display images before and after processing.

In one embodiment, the training system 100 for the neural network model can also include one or more specific expansion acceleration circuit modules not shown in FIG. 1. These modules can be used to accelerate the operation of the neural network applicable to the embodiments of the invention. Those skilled in the art would have general knowledge of computer organization and architecture to understand the hardware composition of the training system 100 for the neural network model in the embodiments of the invention.

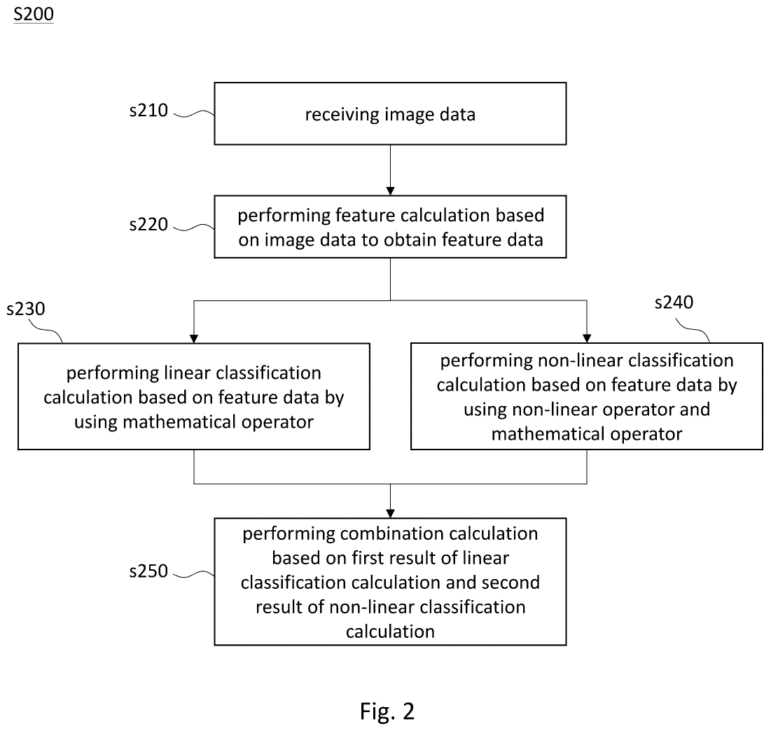

Please refer to FIG. 2, which is a flow chart of a training method for a neural network model according to one embodiment of the invention. The training method s200 can be adopted or performed by the training system 100 for the neural network model of FIG. 1. In one embodiment, any combination of one or more of the central processor 110, the graphics processor 140, and specific expansion acceleration circuit modules can execute multiple instructions to implement the training method s200 for the neural network model. The training method s200 for the neural network model is based on the data structure of the neural network model. Those skilled in the art would have general knowledge of computer neural network models and understand that a computer neural network model includes multiple layers, each layer containing multiple nodes, with connections between the nodes of two different layers. Each connection has trainable weight parameters. Training the neural network model involves training these weight parameters until the neural network model converges.

The training method s200 of the neural network model begins with step s210.

In step s210, an image data is received. The image data can come from the image sensing device 160 and can come from the storage device 170 as well. The method then moves on to step s220.

In step s220, a feature calculation is performed based on the image data to obtain a feature data of the image data. In one embodiment, step s220 includes a linear feature calculation and a non-linear feature calculation, and the obtained feature data includes a linear feature data and a non-linear feature data. The contents of the linear and non-linear feature calculations will be detailed later. The feature data obtained after the feature calculation is then output to the following classification calculation steps s230 and s240.

In step s230, a linear classification calculation is performed based on the feature data by using a mathematical operator. The linear classification calculation can be exemplified by including multiple linear fully connected layer calculation. The first result of the linear classification calculation is then output to the following combination calculation step s250.

In step s240, a non-linear classification calculation is performed based on the feature data by using a non-linear operator and another mathematical operator. The non-linear classification calculation can be exemplified by including multiple non-linear fully connected layer calculation. The second result of the non-linear classification calculation is then output to the following combination calculation step s250.

In step s250, a combination calculation is performed based on the first result of the linear classification calculation and the second result of the non-linear classification calculation. Through the combination calculation, the results of both the linear and non-linear calculations can be integrated more efficiently, thereby achieving a more robust, more effective neural network model architecture.

In one embodiment, the data after the combination calculation step s250 can be outputted. The details of the data output would be understood by those skilled in the art and will not be described here in the embodiments of the invention.

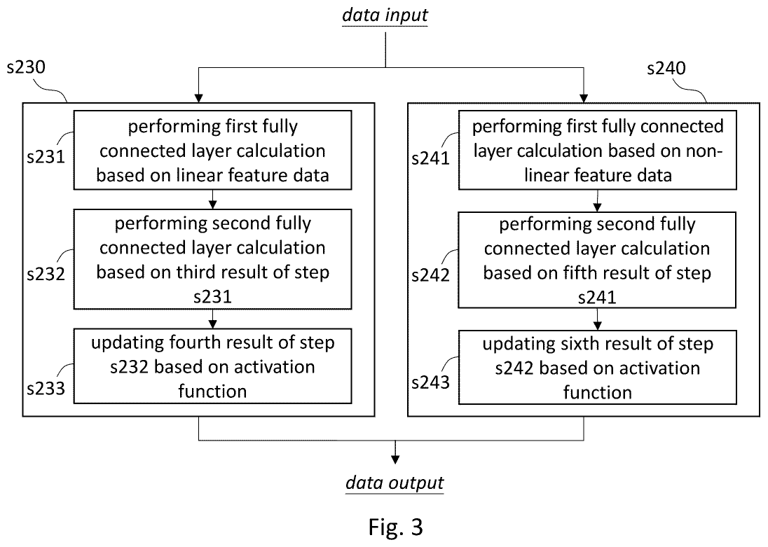

Next, the contents of steps s230 and s240 will be detailed. Please refer to FIG. 3, which is a detail flow chart of the linear and non-linear classification calculations according to one embodiment of the invention.

In the embodiment shown in FIG. 3, step s230 is performed once, and step s240 is performed once as well. As previously described, step s220 includes both the linear and the non-linear feature calculations, and the obtained feature data includes both the linear and the non-linear feature data. The linear feature data is sent to step s230 to perform the linear classification calculation, and the non-linear feature data is sent to step s240 to perform the non-linear classification calculation.

First, the linear classification calculation of step s230 is elaborated.

Step s230 includes the following steps. In step s231, a first fully connected layer calculation is performed based on the linear feature data. In step s232, a second fully connected layer calculation is performed based on a third result of step s231. In step s233, the fourth result of step s232 is updated based on an activation function. Step s231 and step s232 involve linear calculations respectively.

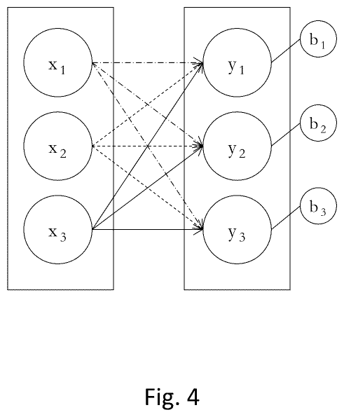

Please P refer to FIG. 3 and FIG. 4 at the same time. FIG. 4 is a schematic diagram of two fully connected layer calculations according to one embodiment of the invention. Step s230 of the present embodiment includes two fully connected layer calculations, namely step s231 and step s232 shown in FIG. 3. The first fully connected layer is a linear fully connected layer having x values (e.g. x₁, x₂, x₃ in FIG. 4). The second fully connected layer is a linear fully connected layer having y values (e.g. y₁, y₂, y₃ in FIG. 4). The feature parameter matrix of the linear classification calculation connecting the two linear fully connected layer calculations can be defined as the function Feature_Weight_Linear(x,y), hereinafter referred to as FWL(x,y), which includes x*y values. In addition, after the feature calculation (step s220) of the image data, more specifically, after the linear feature calculation based on the linear operator, the linear feature data is obtained. Here the linear feature data is defined as the function Image_Feature_Linear(m), hereinafter referred to as IFL(m), which is a one-dimensional numerical matrix of size m after expansion as an example. Further, a linear connection bias weight is specified, indicating that the second linear fully connected layer is connected to a bias neuron with a fixed value unit (e.g. b₁, b₂, b₃ in FIG. 4). The bias weight can be represented as Bias_L(x), and its numerical matrix contains x values, which is the same number as the values in the first linear fully connected layer.

As shown in FIG. 4, each linear fully connected layer calculation includes three values in the present embodiment, and mathematical operators are used here for calculation. The first linear fully connected layer calculation (step s231) can be regarded as the input layer of the linear classification calculation (step s230). The second linear fully connected layer calculation (step s232) can be regarded as the output layer of the linear classification calculation layer (step s230). All the values of the neurons in the second linear fully connected layer calculation are derived from the values of the neurons in the first linear fully connected layer calculation, the feature parameter matrix FWL(x,y), and linear connection bias weight Bias_L(x) through the mathematical operations of the linear operators.

In the present embodiment, the function IFL_In(xᵢ) is defined as the xᵢ^{th} value calculated by the first linear fully connected layer (input layer), and the function IFL_Out(yⱼ) is defined as the yⱼ^{th} value calculated by the second linear fully connected layer (output layer). The function LO_1(IFL_In(xᵢ), FWL(x,y)) is the first mathematical operator, and the function LO_2(IFL_In(xᵢ), FWL(x,y)) is the second mathematical operator. The derivation and calculation of each value in the output layer can be shown by the following equation (1).

$$IFL\_Out ( {y}_{j} ) = LO\_ 2 [ IFL\_ln {( {x}_{i} )}_{i = 1 \sim n} LO\_ 1 ( {x}_{i} , {w}_{ij} ) ] \qquad ( 1 )$$

In one practical example, the first linear operator LO_1 in the equation (1) is a multiplication operator and the second linear operator LO_2 is an addition operator. Based on FIG. 4, the first linear fully connected layer calculation includes three values (x₁, x₂, x₃) and the second linear fully connected layer calculation includes three values (y₁, y₂, y₃). Additionally, a bias weight, which is a linear connection bias weight value matrix, is further included here. The bias weight includes three values (b₁, b₂, b₃). The feature parameter matrix of the linear classification calculation is then FWL(3,3), which includes a total of 9 values (w₁₁, w₁₂, w₁₃, w₂₁, w₂₂, w₂₃, w₃₁, w₃₂, w₃₃). Therefore, each value of the output layer can be obtained as follows.

$${y}_{1} = ( {x}_{1} * {w}_{11} ) + ( {x}_{2} * {w}_{12} ) + ( {x}_{3} * {w}_{13} ) + {b}_{1}$$

$${y}_{2} = ( {x}_{1} * {w}_{21} ) + ( {x}_{2} * {w}_{22} ) + ( {x}_{3} * {w}_{23} ) + {b}_{2}$$

$${y}_{3} = ( {x}_{1} * {w}_{31} ) + ( {x}_{2} * {w}_{32} ) + ( {x}_{3} * {w}_{33} ) + {b}_{3}$$

In the embodiments of the invention, the linear operators are not limited to two, nor are they limited to addition and multiplication operations. The linear operator can include addition, subtraction, multiplication, division, exponentiation, or any combinations thereof.

The fourth result of the second fully connected layer calculation can then be updated based on the activation function in step s233 to enhance the nonlinearity of the calculation result. Exemplarily, the activation function can be a rectified linear unit (ReLu) function, a hyperbolic tangent function, or a sigmoid function. The activated values can be output to step s250 for combination calculation.

Next, the non-linear calculation of step s240 will be elaborated.

Please refer to FIG. 3 and FIG. 4 at the same time. Step s240 includes the following steps. First in step s241, a first fully connected layer calculation based on the non-linear feature data is performed. Next in step s242, a second fully connected layer calculation based on a fifth result of step s241 is performed. Then in step s243, a sixth result of step s242 is updated based on an activation function.

When performing calculations based on the non-linear feature data, the two layers in FIG. 4 can be regarded as two non-linear fully connected layer calculations. In the present embodiment, step s240 includes two non-linear fully connected layer calculations, namely step s241 and step s242 as shown in FIG. 3. The first fully connected layer is a non-linear fully connected layer having x values (e.g. x₁, x₂, x₃ in FIG. 4), and the second fully connected layer is a non-linear fully connected layer having y values (e.g. y₁, y₂, y₃ in FIG. 4). The feature parameter matrix of the non-linear classification calculation connecting the two non-linear fully connected layer calculations can be defined as the function Feature_Weight_Non_Linear(x,y), hereinafter referred to as FWNL(x,y), which includes x*y values. In addition, after the feature calculation (step s220) of the image data, more specifically, after the non-linear feature calculation based on the non-linear feature operator, the non-linear feature data is obtained. Here the non-linear feature data is defined as the function Image_Feature_Non_Linear(m), hereinafter referred to as IFNL(m), which is a one-dimensional numerical matrix of size m after expansion as an example. Further, a non-linear connection bias weight is specified, indicating that the second non-linear fully connected layer is connected to a bias neuron with a fixed value unit (e.g. b₁, b₂, b₃ in FIG. 4)). This bias weight can be represented as Bias_NL(x), and its numerical matrix contains x values, which is the same number as the values in the first non-linear fully connected layer.

As shown in FIG. 4, when performing the non-linear classification calculation, each non-linear fully connected layer calculation includes three values in the present embodiment, and non-linear operators and linear mathematical operators are used here for calculation. The first non-linear fully connected layer calculation (step s241) can be regarded as the input layer of the non-linear classification calculation (step s240). The second non-linear fully connected layer calculation (step s242) can be regarded as the output layer of the non-linear classification calculation layer (step s240). All the values of the neurons in the second non-linear fully connected layer calculation are derived from the values of the neurons in the first non-linear fully connected layer calculation, the feature parameter matrix FWNL(x,y), and non-linear connection bias weight Bias_NL(x) at least through one non-linear operation of at least one non-linear operator.

In the present embodiment, the function INFL_In(xᵢ) is defined as the xᵢ^{th} value calculated by the first non-linear fully connected layer (input layer), and the function IFNL_Out(yⱼ) is defined as the yⱼ^{th} value calculated by the second non-linear fully connected layer (output layer). The function NLO_1[IFNL_In(xᵢ), FWNL(x,y)] is the first operator, and the function NLO_2[IFNL_In(xᵢ), FWNL(x,y)] is the second operator. The derivation and calculation of each value in the output layer can be shown in the following equation (2).

$$IFL\_Out ( {y}_{j} ) = NLO\_ 2 [ IFNL\_ln {( {x}_{i} )}_{i = 1 \sim n} NLO\_ 1 ( {x}_{i} , {w}_{ij} ) ] \qquad ( 2 )$$

In one practical example, the first operator NLO_1 in the equation (2) is a multiplication operator, which is a linear mathematical operator. The second operator NLO_2 is a non-linear operator to perform a max operation. Based on FIG. 4, the first non-linear fully connected layer calculation includes three values (x₁, x₂, x₃) and the second non-linear fully connected layer calculation includes three values (y₁, y₂, y₃). Additionally, a bias weight, which is a non-linear connection bias weight value matrix, is further included here. The bias weight includes three values (b₁, b₂, b₃). The feature parameter matrix of the non-linear classification calculation is then FWNL(3,3), which includes a total of 9 values (w₁₁, w₁₂, w₁₃, w₂₁, w₂₂, w₂₃, w₃₁, w₃₂, w₃₃). Therefore, each value of the output layer can be obtained as follows.

$${y}_{1} = max ( {x}_{1} * {w}_{11} , {x}_{2} * {w}_{12} , {x}_{3} * {w}_{13} , {b}_{1} )$$

$${y}_{2} = max ( {x}_{2} * {w}_{21} , {x}_{2} * {w}_{22} , {x}_{3} * {w}_{23} , {b}_{2} )$$

$${y}_{3} = max ( {x}_{3} * {w}_{31} , {x}_{2} * {w}_{32} , {x}_{3} * {w}_{33} , {b}_{3} )$$

In the embodiments of the invention, the operators are not limited to two, nor are they limited to multiplication and max operations. The linear operator can include addition, subtraction, multiplication, division, exponentiation, or any combinations thereof. The non-linear operator can include max operation, min operation, average operation, or any combinations thereof.

The sixth result of the second fully connected layer calculation can then be updated based on the activation function in step s243 to enhance the nonlinearity of the calculation result. Exemplarily, the activation function can be a Relu function, a hyperbolic tangent function, or a sigmoid function. The activated values can be output to step s250 for combination calculation.

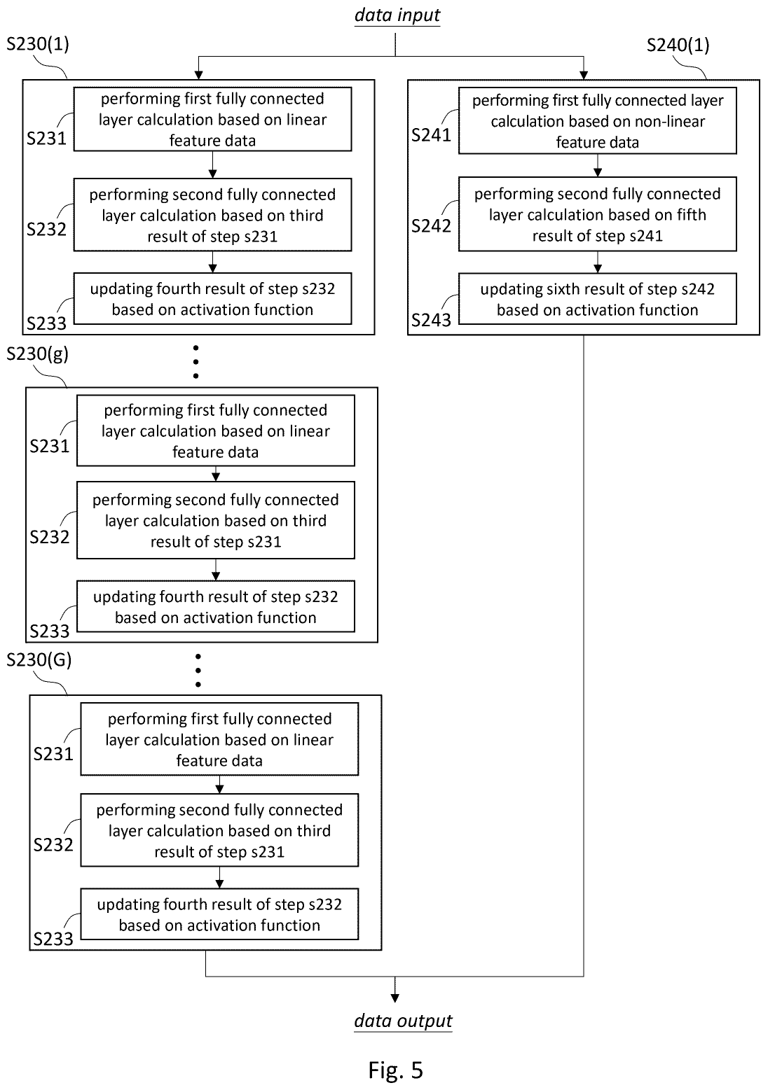

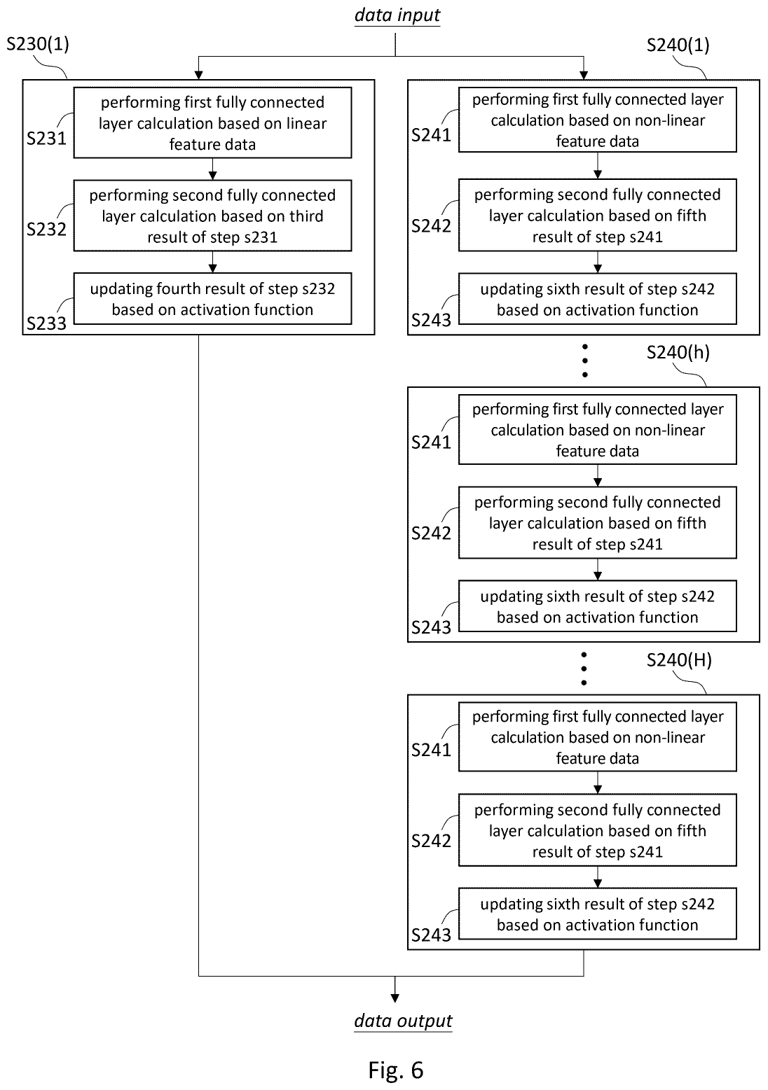

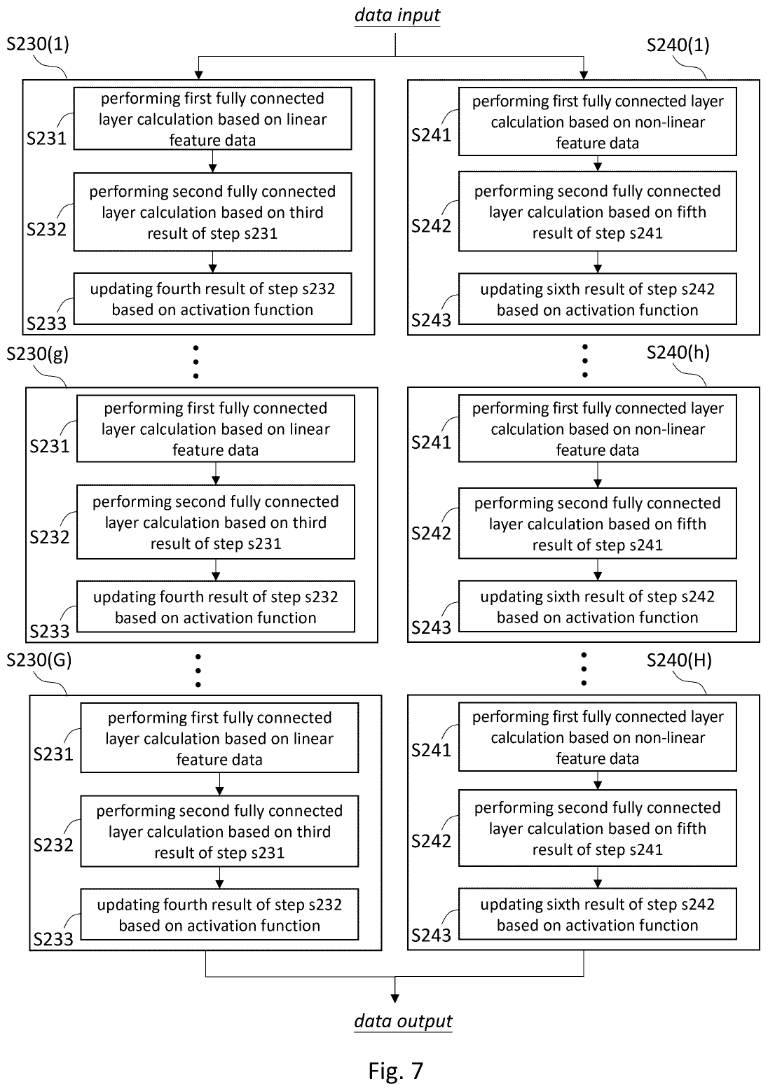

In the embodiment related to FIG. 3, step s230 is performed once, and step s240 is performed once as well. In different embodiments, step s230 and step s240 can be performed several times respectively. Please refer to FIGS. 5-7. FIG. 5 is a detail flow chart of the linear and the non-linear classification calculations according to another embodiment of the invention. FIG. 6 is a detail flow chart of the linear and the non-linear classification calculations according to a further embodiment of the invention. FIG. 7 is a detail flow chart of the linear and the non-linear classification calculations according to yet another embodiment of the invention.

As shown in FIG. 5, the linear classification calculation of step s230 is performed G times, and the g^{th} time linear classification calculation is performed by way of using the first result of the (g−1)^{th} time linear classification calculation as the feature data, where G≥2 and G≥g≥2. The first result of the last linear classification calculation (step s230(G)) is output to step s250. In the present embodiment, the combination calculation of step s250 is performed based on the first result of the G^{th} linear classification calculation (step s230(G)) and the second result of one non-linear classification calculation (step s240(1)).

As shown in FIG. 6, the non-linear classification calculation of step s240 is performed H times, and the h^{th} is performed by way of using the second result of the (h−1)^{th} time non-linear classification calculation as the feature data, where H≥2, H≥h≥2. The second result of the last non-linear classification calculation (step s240(H)) is output to step s250. In the present embodiment, the combination calculation of step s250 is performed based on the first result of one linear classification calculation (step s230(1)) and the second result of the last non-linear classification calculation (step s240(H)).

As shown in FIG. 7, the linear classification calculation of step 230 is performed G times, and the non-linear classification calculation of step s240 is performed H times. The first result of the last linear classification calculation (step s230(G)) and the second result of the last non-linear classification calculation (step s240(H)) are output to step s250. That is, in the present embodiment, the combination calculation of step s250 is performed based on the G^{th} linear classification calculation (step s230(G)) and the H^{th} non-linear classification calculation (step s240(H)).

In step s250, the results of step s230 and step s240 are used to perform the combination calculation, which integrates the results of the linear and the non-linear classification calculations, allowing a more robust and effective neural network model architecture.

In the combination calculation of step s250, the first result of the linear classification calculation of step s230 and the second result of the non-linear calculation of step s240 are integrated using an integration operator. LNL_Operator is used to denote the integration operator and includes linear operations or non-linear operations. For example, the integration operator can be expressed in the following equation.

$$LNL\_Operator = min \{ max [ IFNL\_Out ( {y}_{j} ) , IFL\_Out ( {y}_{j} ) ] , min [ IFNL\_Out ( {y}_{j} ) , IFL\_Out ( {y}_{j} ) ] \}$$

The integration operator can also be exemplified by the following equation.

$$LNL\_Operator = [ 0.5 * IFNL\_Out ( {y}_{j} ) ] + [ 0.5 * IFL\_Out ( {y}_{j} ) ]$$

The content of the integration operator is not limited herein. As long as one or more linear and/or non-linear operators are used to integrate the results of both linear and non-linear classification calculations, such integration operator can be used in the present embodiments of the invention.

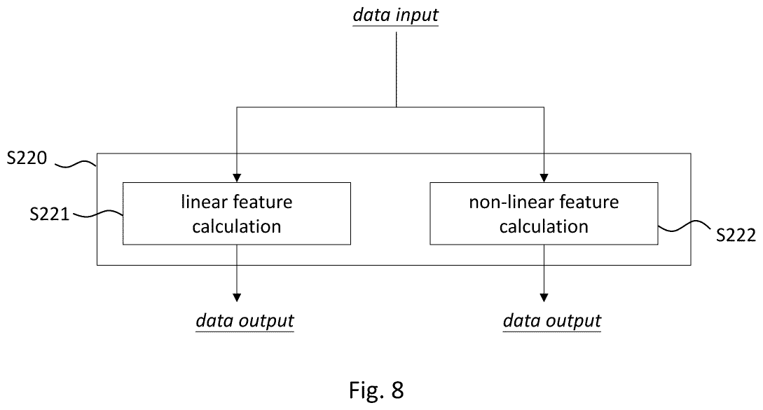

On the other hand, step s220 will now be elaborated in more detail. Both a linear feature calculation and a non-linear calculation can be included in the step of feature calculation. Please refer to FIG. 8, which is a detail flow chart of feature calculation according to one embodiment of the invention.

The feature calculation of step s220 in the present embodiment includes step s221 that performs a linear feature calculation and step s222 that performs a non-linear feature calculation. These two steps s221 and s222 can be executed simultaneously or sequentially, and their order is not limited here in the present embodiment of the invention.

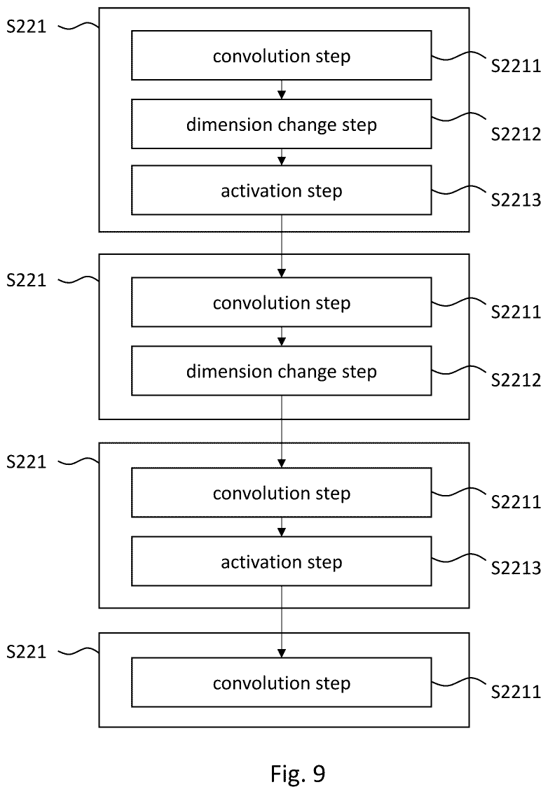

The linear feature calculation can be performed once or multiple times. Please refer to FIG. 9, which is a detail flow chart of a linear feature calculation according to one embodiment of the invention. In the present embodiment, the linear feature calculation of step s221 includes a convolution step s2211. Optionally, step s221 can further include a dimension change step s2212 and/or an activation step s2213. As shown in FIG. 9, the linear feature calculation of step s221 is performed four times, and each step s221 includes at least the convolution step s2211.

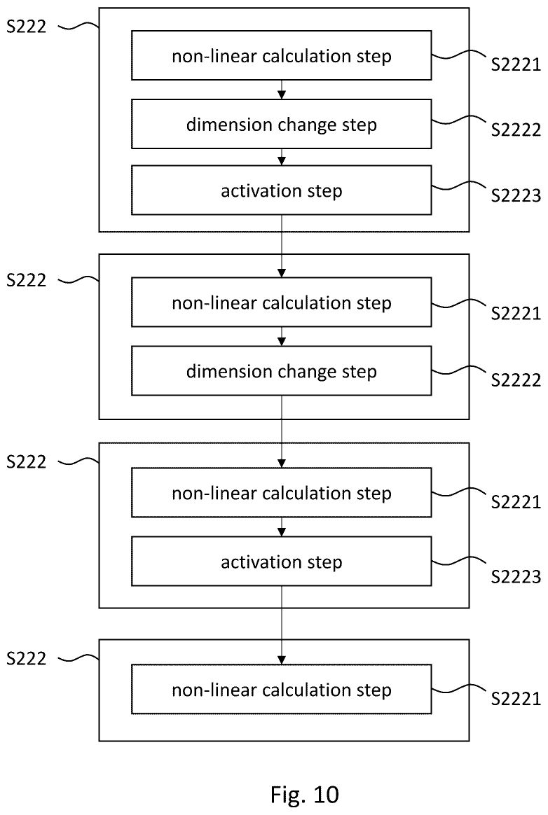

The non-linear feature calculation can also be performed once or multiple times. Please refer to FIG. 10, which is a detail flow chart of a non-linear feature calculation according to one embodiment of the invention. In the present embodiment, the non-linear feature calculation of step s222 includes a non-linear calculation step s2221. Optionally, step s222 can further include a dimension change step s2222 and/or an activation step s2223. As shown in FIG. 10, the non-linear feature calculation of step s222 is performed four times, and each step s222 includes at least the non-linear calculation step s2221.

The training method s200 for the neural network model provided in the present embodiment first performs the feature calculations based on the image data in step s220 to obtain the feature data. Then, in step s230, the feature data undergoes the linear classification calculation and in step s240 undergoes the non-linear classification calculation. Subsequently, in step s250, the results of the classification calculations are integrated. This allows the training method s200 for the neural network model to more efficiently combine the results of both linear and non-linear classifications, providing a greater variability in the feature space. This, in turn, successfully develops a more robust and efficient deep learning network architecture. When the neural network model trained by the training method s200 is practically implemented, it can perform feature classification more effectively.

The architecture of the training system will be detailed below.

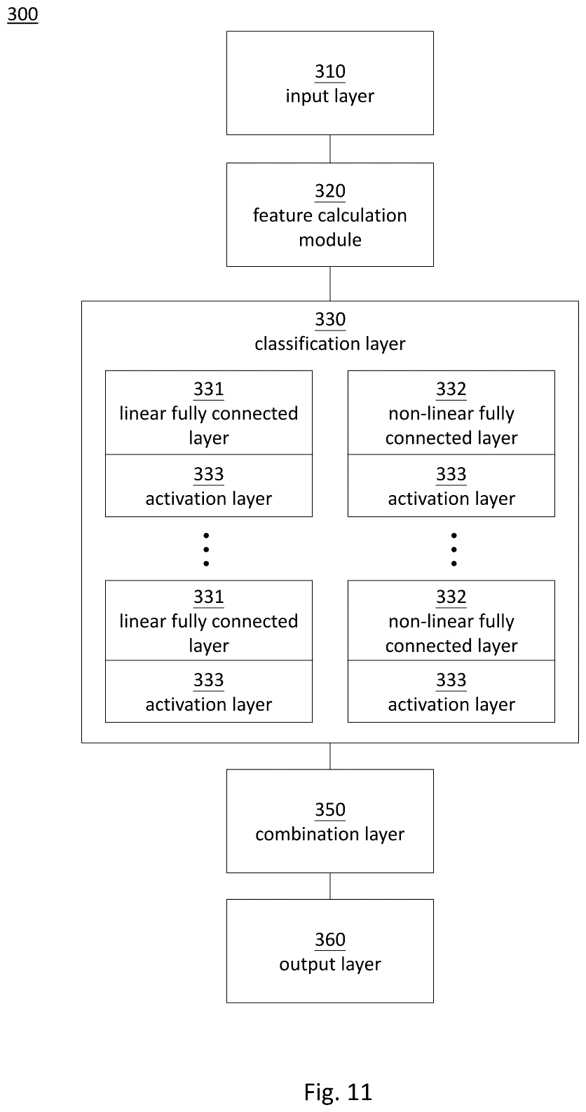

Please refer to FIG. 11, which is a schematic diagram of the architecture of a training system according to one embodiment of the invention. The training system 300 includes at least an input layer 310, a feature calculation module 320, a classification layer 330, a combination layer 350, and an output layer 360. In this embodiment, the training system 300, for example, executes the training method s200 according to the previous embodiments of the present invention. The input layer 310 is used to receive the image data and output the image data to the feature calculation module 320. The feature calculation module 320 is used to perform one or more feature calculations and then output the calculation results to the classification layer 330. The classification layer 330 is used to perform one or more classification calculations, including a linear fully connected layer 331 and a non-linear fully connected layer 332, and optionally includes an activation layer 333. The linear fully connected layer 331 is used to perform linear fully connected layer calculations, and the non-linear fully connected layer 332 is used to perform non-linear fully connected layer calculations. The linear calculation result of the linear fully connected layer 331 and the non-linear calculation result of the non-linear fully connected layer 332 are then output to the combination layer 350. The output layer 360 is used to provide the output result.

According to one embodiment of the invention, a training method for a neural network model is provided. The training method includes: (a) receiving an image data; (b) performing a feature calculation based on the image data to obtain a feature data; (c) performing a linear classification calculation based on the feature data by using a mathematical operator; (d) performing a non-linear classification calculation based on the feature data by using a non-linear operator and another mathematical operator; and (e) performing a combination calculation based on a first result of the linear classification calculation and a second result of the non-linear classification calculation.

Preferably, the step (c) is performed G times, and the g^{th} time linear classification calculation is performed by way of using the first result of the (g−1)^{th} time linear classification calculation as the feature data, where G≥2 and G≥g≥2.

Preferably, the step (e) is performed based on the first result of the G^{th} time linear classification calculation and the second result of the non-linear classification calculation.

Preferably, the step (b) includes: performing a linear feature calculation to obtain a linear feature data.

Preferably, the step (c) includes: (c1) performing a first fully connected layer calculation based on the linear feature data; (c2) performing a second fully connected layer calculation based on a third result of the step (c1); and (c3) updating a fourth result of the step (c2) based on an activation function.

Preferably, the step (d) is performed H times, and the h^{th} time non-linear classification calculation is performed by way of using the second result of the (h−1)^{th} time non-linear classification calculation as the feature data, where H≥2 and H≥h≥2.

Preferably, the step (e) is performed based on the first result of the linear classification calculation and the second result of the H^{th} time non-linear classification calculation.

Preferably, the step (b) includes: performing a non-linear feature calculation to obtain a non-linear feature data.

Preferably, the step (d) includes: (d1) performing a first fully connected layer calculation based on the non-linear feature data; (d2) performing a second fully connected layer calculation based on a fifth result of the step (d1); and (d3) updating a sixth result of the step (d2) based on an activation function.

According to another embodiment of the invention, a training system for a neural network model is provided. The training system includes: a memory configured for storing the neural network model and a plurality of instructions; and a processor configured for executing the instructions to perform a training method comprising: (a) receiving an image data; (b) performing a feature calculation based on the image data to obtain a feature data; (c) performing a linear classification calculation based on the feature data by using a mathematical operator; (d) performing a non-linear classification calculation based on the feature data by using a non-linear operator and another mathematical operator; and (e) performing a combination calculation based on a first result of the linear classification calculation and a second result of the non-linear classification calculation, thereby training the neural network model.

The embodiments of the invention provide the training method and the training system for the neural network model. The linear and non-linear classification calculations can be performed through deep learning, which improves the efficiency of classification process, and which is advantageous for subsequent computational applications. The neural network model trained thereby is more sensitive to certain features of the image and is more capable of detecting images with these subtle features, therefore providing a more robust and efficient deep learning network architecture.

While the present invention has been disclosed above through a number of embodiments, those embodiments are not intended to be restrictive of the scope of the invention. A person who is skilled in the art will be able to make various changes or modifications to the disclosed embodiments without departing from the spirit or scope of the invention. The scope of the patent protection sought by the applicant is defined by the appended claims.

What is claimed is:

1. A training method for a neural network model, comprising:
(a) receiving an image data;
(b) performing a feature calculation based on the image data to obtain a feature data;
(c) performing a linear classification calculation based on the feature data by using a mathematical operator;
(d) performing a non-linear classification calculation based on the feature data by using a non-linear operator and another mathematical operator; and
(e) performing a combination calculation based on a first result of the linear classification calculation and a second result of the non-linear classification calculation.

2. The training method of claim 1, wherein the step (c) is performed G times, and the g^{th} time linear classification calculation is performed by way of using the first result of the (g−1)^{th} time linear classification calculation as the feature data, where G≥2 and G≥g≥2.

3. The training method of claim 2, wherein the step (e) is performed based on the first result of the G^{th} time linear classification calculation and the second result of the non-linear classification calculation.

4. The training method of claim 3, wherein the step (b) comprises:
performing a linear feature calculation to obtain a linear feature data.

5. The training method of claim 4, wherein the step (c) comprises:
(c1) performing a first fully connected layer calculation based on the linear feature data;
(c2) performing a second fully connected layer calculation based on a third result of the step (c1); and
(c3) updating a fourth result of the step (c2) based on an activation function.

6. The training method of claim 1, wherein the step (d) is performed H times, and the h^{th} time non-linear classification calculation is performed by way of using the second result of the (h−1)^{th} time non-linear classification calculation as the feature data, where H≥2 and H≥h≥2.

7. The training method of claim 6, wherein the step (e) is performed based on the first result of the linear classification calculation and the second result of the H^{th} time non-linear classification calculation.

8. The training method of claim 7, wherein the step (b) comprises:
performing a non-linear feature calculation to obtain a non-linear feature data.

9. The training method of claim 8, wherein the step (d) comprises:
(d1) performing a first fully connected layer calculation based on the non-linear feature data;
(d2) performing a second fully connected layer calculation based on a fifth result of the step (d1); and
(d3) updating a sixth result of the step (d2) based on an activation function.

10. A training system for a neural network model, comprising:
a memory configured for storing the neural network model and a plurality of instructions; and
a processor configured for executing the instructions to perform a training method comprising: (a) receiving an image data; (b) performing a feature calculation based on the image data to obtain a feature data; (c) performing a linear classification calculation based on the feature data by using a mathematical operator; (d) performing a non-linear classification calculation based on the feature data by using a non-linear operator and another mathematical operator; and (e) performing a combination calculation based on a first result of the linear classification calculation and a second result of the non-linear classification calculation.
